(19) United States
(12) Patent Application Publication
(10) Pub. No.: US 2015/0312402 A1
(43) Pub. Date: Oct. 29, 2015

(54) COMPUTING SYSTEM WITH CONTROL MECHANISM AND METHOD OF OPERATION THEREOF

(71) Applicant: Samsung Electronics Co., Ltd., Suwon-si (KR)

(72) Inventors: Ke-Yu Chen, Seattle, WA (US); Daniel Ashbrook, Sunnyvale, CA (US); Sung Hyuck Lee, Menlo Park, CA (US); James M.A. Begole, Los Altos, CA (US)

(73) Assignee: Samsung Electronics Co., Ltd., Suwon-si (KR)

(21) Appl. No.: 14/264,457

(22) Filed: Apr. 29, 2014

(51) Int. Cl. H04M 1/725; G06F 3/01; H04W 4/00

(52) U.S. Cl. CPC H04M 1/72563; H04W 4/008; G06F 3/017

(57) ABSTRACT

A computing system includes: a communication unit configured to communicate a client recognition pattern for detecting an agent device within a detection proximity; and a control unit, coupled to the communication unit, configured to: determine a detection quantity based on the client recognition pattern, assign a channel bin based on comparing the detection quantity to a channel occupancy available, and generate an activity command based on an activity request pattern assigned to the channel bin for controlling a device functionality of an electronic device.

### TECHNICAL FIELD

An embodiment of the present invention relates generally to a computing system, and more particularly to a system for control mechanism.

### BACKGROUND

Modern portable client and industrial electronics, especially client devices such as cellular phones, portable digital assistants, and combination devices are providing increasing levels of functionality to support modem life including location-based information services. Research and development in the existing technologies can take a myriad of different directions.

As users become more empowered with the growth of devices, new and old paradigms begin to take advantage of this new device space. There are many technological solutions to take advantage of this new device capability to communicate with other devices. One existing approach is to use device movement to provide access through a mobile device, such as a cell phone, smart phone, or a personal digital assistant.

Access services allow users to create, transfer, store, and/or control information in order for users to create, transfer, store, and control in the “real world.” One such use of personalized content services is to efficiently transfer or guide users to the desired product or service.

Thus, a need still remains for a computing system with control mechanism for aiding the access of devices. In view of the ever-increasing commercial competitive pressures, along with growing client expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### SUMMARY

An embodiment of the present invention provides a computing system including: a communication unit configured to communicate a client recognition pattern for detecting an agent device within a detection proximity; and a control unit, coupled to the communication unit, configured to: determine a detection quantity based on the client recognition pattern, assign a channel bin based on comparing the detection quantity to a channel occupancy available, and generate an activity command based on an activity request pattern assigned to the channel bin for controlling a device functionality of an electronic device.

An embodiment of the present invention provides a computing system including: a control unit configured to: determine an entry gesture based on a movement direction of a device posture, generate an instruction code having an action type of a device functionality, generate an activity request pattern having the instruction code based on the entry gesture, and a communication unit, coupled to the control unit, configured to communicate an activity request pattern for controlling the device functionality of an electronic device.

An embodiment of the present invention provides a method of operation of a computing system including: determining a detection quantity based on a client recognition pattern received; assigning a channel bin based on comparing the detection quantity to a channel occupancy available; and generating an activity command with a control unit based on an activity request pattern assigned to the channel bin for controlling a device functionality of an electronic device.

An embodiment of the present invention provides a method of operation of a computing system including: determining an entry gesture based on a movement direction of a device posture; generating an instruction code having an action type of a device functionality; generating an activity request pattern with a control unit having the instruction code based on the entry gesture for controlling the device functionality of an electronic device.

An embodiment of the present invention provides a non-transitory computer readable medium including instructions for execution by a control unit including: determining a detection quantity based on a client recognition pattern received; assigning a channel bin based on comparing the detection quantity to a channel occupancy available; and generating an activity command based on an activity request pattern assigned to the channel bin for controlling a device functionality of an electronic device.

An embodiment of the present invention provides a non-transitory computer readable medium including instructions for execution by a control unit including: determining an entry gesture based on a movement direction of a device posture; generating an instruction code having an action type of a device functionality; generating an activity request pattern having the instruction code based on the entry gesture for controlling the device functionality of an electronic device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with control mechanism in an embodiment of the present invention.

FIG. 2 is an example of an architectural diagram of the computing system for an agent device requesting an electronic device to execute an activity command.

FIG. 3 is an example of a handshaking process of the computing system between the agent device and the electronic device.

FIG. 4 is examples of an entry gesture performed on the agent device of FIG. 2.

FIG. 5 is an example of a channel bin.

FIG. 6 is an exemplary block diagram of the computing system.

FIG. 7 is a control flow of the computing system.

### DETAILED DESCRIPTION

The following embodiments of the present invention provide an agent device to control a device functionality of an electronic device remotely. The agent device can detect a server presence and the electronic device can detect a client presence to exchange communication pattern for the agent device to request the electronic device to execute an activity command to control the device functionality.

An embodiment of a present invention can determine a detection quantity based on a client recognition pattern received can improve the efficiency of assigning a channel bin. By limiting the assignment of the channel bin based on a channel occupancy, the embodiment of the present invention can assign the agent device to the channel bin with a channel availability. As a result, the embodiment of the present invention can generate the activity command based on an activity request pattern with the channel bin assigned for optimal allocation of a communication channel to control the device functionality of the electronic device.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in the embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

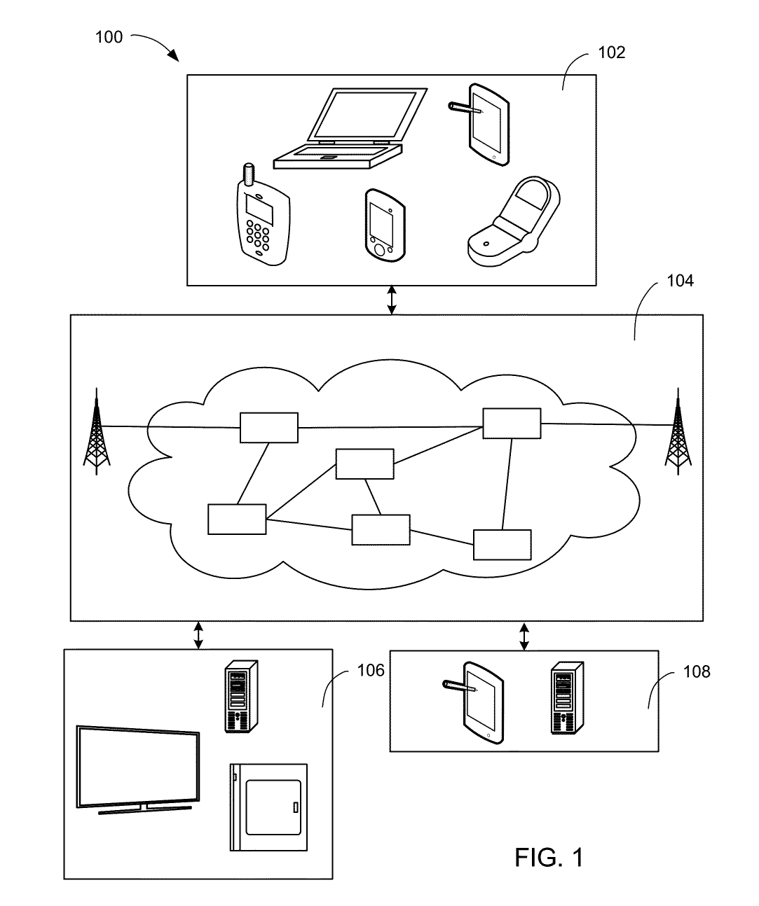

Referring now to FIG. 1, therein is shown a computing system 100 with control mechanism in an embodiment of the present invention. The computing system 100 includes a first device 102, such as a client or a server, connected to a second device 106, such as a client or server. The first device 102 can communicate with the second device 106 with a communication path 104, such as a wireless or wired network. The computing system 100 can also include a third device 108 connected to the first device 102, the second device 106, or a combination thereof with the communication path 104. The third device 108 can be a client or server.

For example, the first device 102 or the third device 108 can be of any of a variety of display devices, such as a cellular phone, personal digital assistant, wearable digital device, tablet, notebook computer, television (TV), automotive telematic communication system, or other multi-functional mobile communication or entertainment device. The first device 102 or the third device 108 can be a standalone device, or can be incorporated with a vehicle, for example a car, truck, bus, aircraft, boat/vessel, or train. The first device 102 or the third device 108 can couple to the communication path 104 to communicate with the second device 106.

For illustrative purposes, the computing system 100 is described with the first device 102 or the third device 108 as a mobile device, although it is understood that the first device 102 or the third device 108 can be different types of devices. For example, the first device 102 or the third device 108 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof. For another example, the second device 106 can include TV, appliances, such as washing machine or refrigerator, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102 or the third device 108. The second device 106 can also be a client type device as described for the first device 102 or the third device 108.

In another example, the first device 102, the second device 106, or the third device 108 can be a particularized machine, such as a mainframe, a server, a cluster server, a rack mounted server, or a blade server, or as more specific examples, an IBM System z10™ Business Class mainframe or a HP ProLiant ML™ server. Yet another example, the first device 102, the second device 106, or the third device 108 can be a particularized machine, such as a portable computing device, a thin client, a notebook, a netbook, a smartphone, personal digital assistant, or a cellular phone, and as specific examples, an Apple iPhone™, Android™ smartphone, or Windows™ platform smartphone.

For illustrative purposes, the computing system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, aircraft, boat/vessel, or train.

Also for illustrative purposes, the computing system 100 is shown with the second device 106 and the first device 102 or the third device 108 as end points of the communication path 104, although it is understood that the computing system 100 can have a different partition between the first device 102, the second device 106, the third device 108, and the communication path 104. For example, the first device 102, the second device 106, the third device 108 or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, wireless High-Definition Multimedia Interface (HDMI), Near Field Communication (NFC), Infrared Data Association standard (IrDA), wireless fidelity (WiFi), and worldwide interoperability for microwave access (WiMAX) are examples of wireless communication that can be included in the communication path 104. Ethernet, HDMI, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

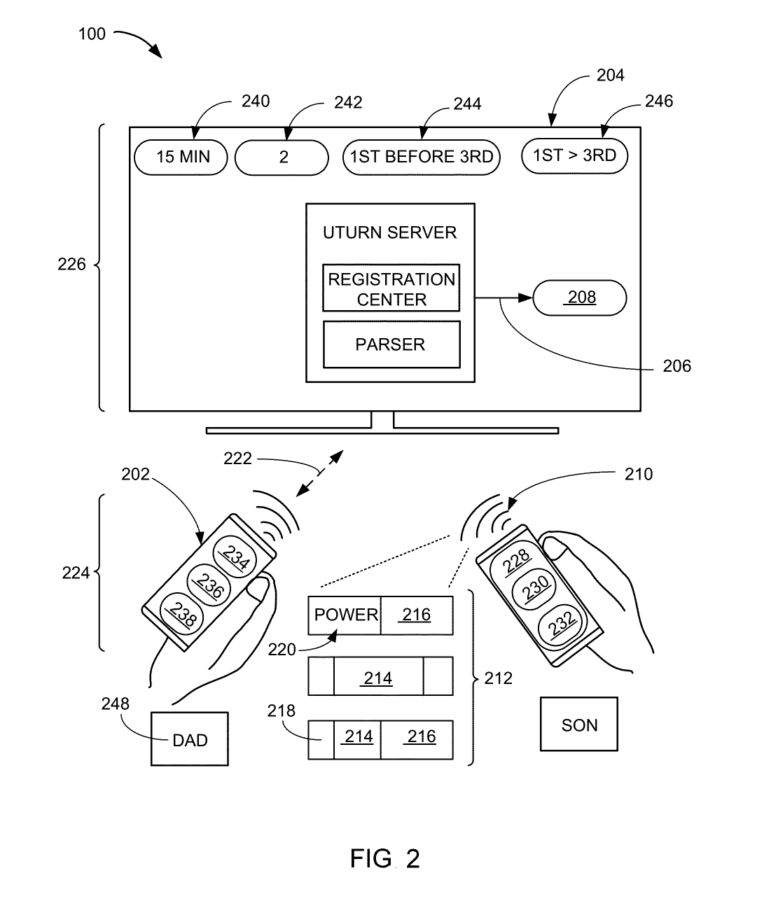

Referring now to FIG. 2, therein is shown an example of an architectural diagram of the computing system 100 for an agent device 202 requesting an electronic device 204 to execute an activity command 206. For clarity and brevity, the discussion of an embodiment of the present invention will be described with the agent device 202 as the first device 102 of FIG. 1 or the third device 108 of FIG. 1 and the second device 106 of FIG. 1 as the electronic device 204. More specifically, the embodiments of the present invention will describe the first device 102, the third device 108, or a combination thereof requesting the second device 106 to perform an operation based on the request. However, the first device 102, the second device 106, and the third device 108 can be discussed interchangeably.

The electronic device 204 is a device that provides a service based on a request. For example, the electronic device 204 can provide the device functionality 208 based on the request by the agent device 202. The activity command 206 is a directive to execute the device functionality 208. The device functionality 208 is an invocable activity of a device. For example, the electronic device 204 can execute the activity command 206 to invoke the device functionality 208 of raising the volume.

The agent device 202 is a device sending a request to the electronic device 204 to perform the device functionality 208. For example the agent device 202 can send an activity request pattern 210 to request the electronic device 204 to execute the activity command 206. The activity request pattern 210 is a request to execute the activity command 206. For example, the agent device 202 can transmit the activity request pattern 210 as a mechanical wave, an electromagnetic wave, or a combination thereof. For further example, the activity request pattern 210 can represent an ultrasonic tone.

The activity request pattern 210 can include an instruction code 212. The instruction code 212 is a data structure containing information detailing the device functionality 208 to be executed. The instruction code 212 can include an action segment 214, a data segment 216, a control segment 218, or a combination thereof.

The action segment 214 is a data containing information regarding an action type 220 for the device functionality 208. The action type 220 is a categorization of the device functionality 208. For example, the action type 220 can include the device functionality 208 representing volume control, play/pause a video, zoom in/out, forward/backward, or a combination thereof of the electronic device 204 representing a TV.

The data segment 216 is a data containing command on controlling the device functionality 208. For example, the data segment 216 can include a command to raise the volume by 3 levels. The control segment 218 is a data containing a flag to determine whether the instruction code 212 is a binary or non-binary action. For example, the binary action can represent the device functionality 208 including two options. The non-binary action can represent the device functionality 208 including more than two options. As an example, the binary action can represent “on” or “off.” The non-binary action can represent different levels of volume to control the audio level of a TV.

The agent device 202 can transmit the activity request pattern 210 if the agent device 202 is within a detection proximity 222. The detection proximity 222 is a distance in space where the agent device 202 and the electronic device 204 can communicate. The distance can be set as a setting, based on factors, or a combination thereof. Some factors can include the interference of transmission or reception in the environment from other devices or sources of signaling.

For example, if the agent device 202 is within the detection proximity 222, the electronic device 204 can detect a client presence 224. If the electronic device 204 is within the detection proximity 222, the agent device 202 can detect a server presence 226. The client presence 224 is awareness by the electronic device 204 of the agent device 202 within the detection proximity 222. The server presence 226 is awareness by the agent device 202 of the electronic device 204 within the detection proximity 222.

A mode type 228 is a categorization of a device state. For example, the agent device 202 can have the mode type 228 representing a transmission mode 230, a non-transmission mode 232, or a combination thereof. The transmission mode 230 is a device state where the agent device 202 can communicate with the electronic device 204. The non-transmission mode 232 is a device state where the agent device 202 is not communicating with the electronic device 204. For example, if the user is using a device application 234 on the agent device 202 irrelevant to controlling the device functionality 208 of the electronic device 204, the agent device 202 can be in the non-transmission mode 232. The agent device 202 and the electronic device 204 can communicate with or without internet connection. As an example for communication without internet connection, the agent device 202 and the electronic device 204 can communicate by transmitting ultrasonic tone to one another.

The device application 234 can represent software running on the agent device 202, the electronic device 204, or a combination thereof. An application status 236 is a state of the device application 234. For example, the device application 234 can represent a remote control application to control the electronic device 204 by the agent device 202. If the agent device 202 is within the detection proximity 222, thus the server presence 226 is detected, the computing system 100 can change the mode type 228 from the non-transmission mode 232 to the transmission mode 230 and change the application status 236 to activate the remote control application.

An inactivity time 238 is time duration of the agent device 202 making no requests to the electronic device 204. A time threshold 240 is maximum time duration allowed for the inactivity time 238 before the mode type 228 switches from the transmission mode 230 to the non-transmission mode 232. For example, the time threshold 240 can represent 15 minutes. The agent device 202 can be placed on a table with the inactivity time 238 of 20 minutes. The computing system 100 can change the mode type 228 from the transmission mode 230 to the non-transmission mode 232.

A plurality of the agent device 202 can make request to control the electronic device 204. A detection quantity 242 is a number of the client presence 224 detected by the electronic device 204. A request timing 244 is a time sequence for when the agent device 202 made a request to the electronic device 204. A device priority 246 is a level importance placed on one device over another device. For example, the device priority 246 can be placed on the agent device 202 with a user profile 248 of a parent over the agent device 202 with the user profile 248 of a child. The user profile 248 is personal information. For example, the user profile 248 can include the name, gender, age, occupation, or a combination thereof regarding the user of the agent device 202.

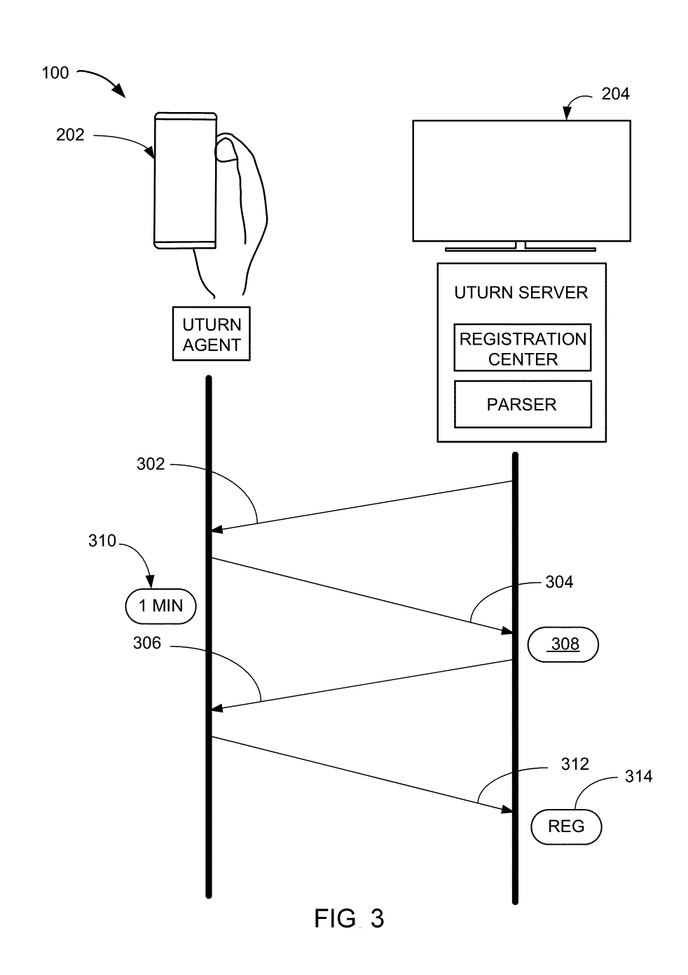

Referring now to FIG. 3, therein is shown an example of a handshaking process of the computing system 100 between the agent device 202 and the electronic device 204. The electronic device 204 can transmit a server recognition pattern 302. The server recognition pattern 302 is a notification to broadcast the server presence 226 of FIG. 2. For example, the electronic device 204 can transmit the server recognition pattern 302 as a mechanical wave, an electromagnetic wave, or a combination thereof. For further example, the server recognition pattern 302 can represent an ultrasonic tone.

The agent device 202 can transmit a client recognition pattern 304. The client recognition pattern 304 is a notification to broadcast the client presence 224 of FIG. 2. For example, the agent device 202 can transmit the client recognition pattern 304 as a mechanical wave, an electromagnetic wave, or a combination thereof. For further example, the client recognition pattern 304 can represent an ultrasonic tone.

The electronic device 204 can transmit a peak pattern 306. The peak pattern 306 is a notification to inform the availability of the electronic device 204 to the agent device 202. For example, the electronic device 204 can transmit the peak pattern 306 as a mechanical wave, an electromagnetic wave, or a combination thereof. For further example, the peak pattern 306 can represent an ultrasonic tone.

A setup possibility 308 is a prospect of the agent device 202 establishing communication with the electronic device 204 to control the device functionality 208 of the electronic device 204. More specifically, if the electronic device 204 transmits the peak pattern 306, the setup possibility 308 can represent “yes” because the electronic device 204 is available. In contrast, if the electronic device 204 does not transmit the peak pattern 306 to the agent device 202, the setup possibility 308 can represent “no” because the electronic device 204 is unavailable. A request window 310 is a maximum timeframe allowed for receiving the peak pattern 306 after communicating the client recognition pattern 304.

The agent device 202 can transmit a confirmation pattern 312. The confirmation pattern 312 is a notification to inform the awareness by the agent device 202 that the electronic device 204 is available. For example, the agent device 202 can transmit the confirmation pattern 312 as a mechanical wave, an electromagnetic wave, or a combination thereof. For further example, the confirmation pattern 312 can represent an ultrasonic tone. A device registration 314 is the electronic device 204 registering the agent device 202 to allow control of the device functionality 208 of the electronic device 204. For example, the electronic device 204 can determine the device registration 314 after receiving the confirmation pattern 312 from the agent device 202.

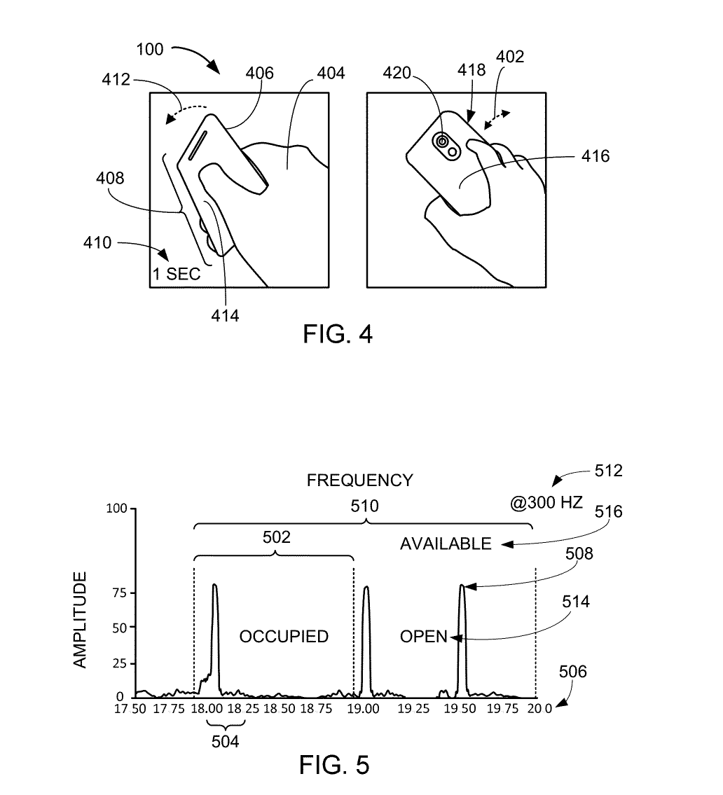

Referring now to FIG. 4, therein is shown examples of an entry gesture 402 performed on the agent device 202 of FIG. 2. The entry gesture 402 is a user entry 404 detected and comprehended by the computing system 100. For example, the user entry 404 can represent a tap, a swipe, a pinch, a turn, or a combination thereof. For another example, the user entry 404 can represent the user of the computing system 100 pointing the agent device 202 towards the electronic device 204 of FIG. 2.

The computing system 100 can detect and comprehend the tap, the swipe, the pinch, the turn, or a combination thereof as the entry gesture 402. For a specific example, the computing system 100 can determine the entry gesture 402 based on a detection area 406, a device posture 408, a contact duration 410, a movement direction 412, or a combination thereof.

The detection area 406 is surface of the agent device 202 to receive the user entry 404. For example, the detection area 406 can include a display interface 414, a device backside 416, a device side 418, or a combination thereof. The contact duration 410 is a length of time a contact is made on the detection area 406. For example, if the user entry 404 makes a contact with the display interface 414 for the contact duration 410 of less than 1 second, the computing system 100 can determine the user entry 404 as the entry gesture 402 of a tap.

The device posture 408 is an orientation of the agent device 202. The movement direction 412 is a change in an orientation of the agent device 202. The user can change the device posture 408 by turning the agent device 202 towards the movement direction 412 of clockwise, counterclockwise, or a combination thereof. The movement direction 412 can represent turning the agent device 202 along the x, y, and z coordinates. For a specific example, the user can change the device posture 408 by pointing the agent device 202 towards the electronic device 204 for a time period, such as 2 seconds. The computing system 100 can detect the change in the device posture 408 or the movement direction 412 with a detecting sensor 420. The detecting sensor 420 can represent accelerometer, magnetometer, gyroscope, microphone, or the combination thereof.

Referring now to FIG. 5, therein is shown an example of a channel bin 502. The channel bin 502 is a group of a communication channel 504. The channel bin 502 allows a plurality of the agent device 202 of FIG. 2 to simultaneously communicate with the electronic device 204 of FIG. 2. For example, the electronic device 204 can assign one instance of the channel bin 502 to the agent device 202 representing the first device 102 of FIG. 1 and another instance of the channel bin 502 to the gent device 202 representing the third device 108 of FIG. 2 for accepting multiple requests from multiple instances of the agent device 202.

The communication channel 504 is a medium used to transmit information. For example, the communication channel 504 can be used to convey information signal between the agent device 202 and the electronic device 204. For example, the communication channel 504 can be selected from a plurality of a communication frequency 506 ranging from 18 kilohertz (kHz) to 21 kHz. The communication frequency 506 is a number of cycles per unit for a mechanical wave, an electromagnetic wave, or a combination thereof. A channel peak 508 is the communication frequency 506 having a highest amplitude. For example, the channel peak 508 for the channel bin 502 between 18 kHz and 18.5 kHz can be at the communication frequency 506 of 18.01 kHz.

A frequency range 510 is a scope of a plurality of the communication frequency 506 considered to determine the channel bin 502. For example, the frequency range 510 can represent the communication frequency 506 ranging from 18 kHz to 21 kHz. A frequency interval 512 is a size of the communication channel 504 to segment the frequency range 510. For example, the frequency interval 512 can represent 300 hertz (Hz). The frequency range 510 can represent from 18 kHz to 21 kHz. The computing system 100 can segment the frequency range 510 with the frequency interval 512 to generate 10 instances of the communication channel 504. Moreover, the computing system 100 can group 5 instances of the communication channel 504 to generate the channel bin 502. As a result, 2 instances of the channel bin 502 can be generated.

A channel occupancy 514 is a status of whether the channel bin 502 is assigned or not. A channel availability 516 is a result of whether the channel bin 502 is available or not based on the channel occupancy 514. For example, the electronic device 204 can assign the channel bin 502 if the channel occupancy 514 represents unoccupied. As a result, the electronic device 204 can inform the channel availability 516 to the agent device 202.

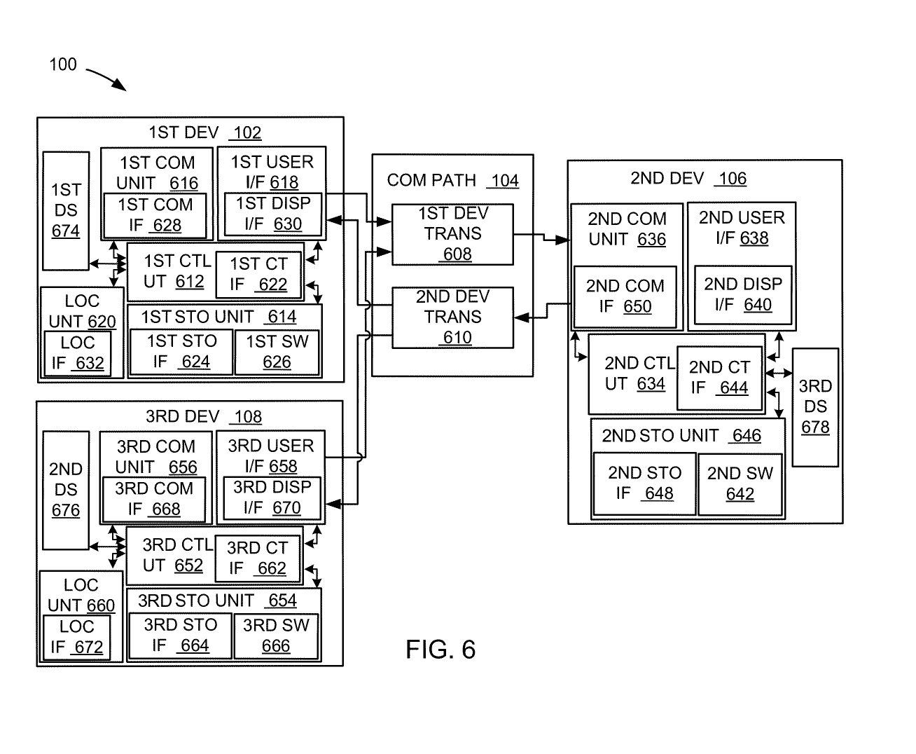

Referring now to FIG. 6, therein is shown an exemplary block diagram of the computing system 100. The computing system 100 can include the first device 102, the third device 108, the communication path 104, and the second device 106. The first device 102 or the third device 108 can send information in a first device transmission 608 over the communication path 104 to the second device 106. The second device 106 can send information in a second device transmission 610 over the communication path 104 to the first device 102 or the third device 108.

For illustrative purposes, the computing system 100 is shown with the first device 102 or the third device 108 as a client device, although it is understood that the computing system 100 can have the first device 102 or the third device 108 as a different type of device. For example, the first device 102 or the third device 108 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 or the third device 108 will be described as a client device and the second device 106 will be described as an electronic device. The embodiment of the present invention is not limited to this selection for the type of devices. The selection is an example of the present invention.

The first device 102 can include a first control unit 612, a first storage unit 614, a first communication unit 616, a first user interface 618, and a location unit 620. The first control unit 612 can include a first control interface 622. The first control unit 612 can execute a first software 626 to provide the intelligence of the computing system 100.

The first control unit 612 can be implemented in a number of different manners. For example, the first control unit 612 can be a processor, an application specific integrated circuit (ASIC) an embedded processor, a microprocessor, a hardware control logic, a hardware finite state machine (FSM), a digital signal processor (DSP), or a combination thereof. The first control interface 622 can be used for communication between the first control unit 612 and other functional units in the first device 102. The first control interface 622 can also be used for communication that is external to the first device 102.

The first control interface 622 can receive information from the other functional units or from external sources, or can transmit information to the other functional units or to external destinations. The external sources and the external destinations refer to sources and destinations physically separate from to the first device 102.

The first control interface 622 can be implemented in different ways and can include different implementations depending on which functional units or external units are being interfaced with the first control interface 622. For example, the first control interface 622 can be implemented with a pressure sensor, an inertial sensor, a microelectromechanical system (MEMS), optical circuitry, waveguides, wireless circuitry, wireline circuitry, or a combination thereof.

The location unit 620 can generate location information, current heading, and current speed of the first device 102, as examples. The location unit 620 can be implemented in many ways. For example, the location unit 620 can function as at least a part of a global positioning system (GPS), an inertial navigation system, a cellular-tower location system, a pressure location system, or any combination thereof.

The location unit 620 can include a location interface 632. The location interface 632 can be used for communication between the location unit 620 and other functional units in the first device 102. The location interface 632 can also be used for communication that is external to the first device 102.

The location interface 632 can receive information from the other functional units or from external sources, or can transmit information to the other functional units or to external destinations. The external sources and the external destinations refer to sources and destinations physically separate from the first device 102.

The location interface 632 can include different implementations depending on which functional units or external units are being interfaced with the location unit 620. The location interface 632 can be implemented with technologies and techniques similar to the implementation of the first control interface 622.

The first storage unit 614 can store the first software 626. The first storage unit 614 can also store the relevant information, such as advertisements, points of interest (POI), navigation routing entries, or any combination thereof. The relevant information can also include news, media, events, or a combination thereof from the third party content provider.

The first storage unit 614 can be a volatile memory, a nonvolatile memory, an internal memory, an external memory, or a combination thereof. For example, the first storage unit 614 can be a nonvolatile storage such as non-volatile random access memory (NVRAM), Flash memory, disk storage, or a volatile storage such as static random access memory (SRAM).

The first storage unit 614 can include a first storage interface 624. The first storage interface 624 can be used for communication between and other functional units in the first device 102. The first storage interface 624 can also be used for communication that is external to the first device 102.

The first storage interface 624 can receive information from the other functional units or from external sources, or can transmit information to the other functional units or to external destinations. The external sources and the external destinations refer to sources and destinations physically separate from the first device 102.

The first storage interface 624 can include different implementations depending on which functional units or external units are being interfaced with the first storage unit 614. The first storage interface 624 can be implemented with technologies and techniques similar to the implementation of the first control interface 622.

The first communication unit 616 can enable external communication to and from the first device 102. For example, the first communication unit 616 can permit the first device 102 to communicate with the first device 102 of FIG. 1, an attachment, such as a peripheral device or a computer desktop, and the communication path 104.

The first communication unit 616 can also function as a communication hub allowing the first device 102 to function as part of the communication path 104 and not limited to be an end point or terminal unit to the communication path 104. The first communication unit 616 can include active and passive components, such as microelectronics or an antenna, for interaction with the communication path 104.

The first communication unit 616 can include a first communication interface 628. The first communication interface 628 can be used for communication between the first communication unit 616 and other functional units in the first device 102. The first communication interface 628 can receive information from the other functional units or can transmit information to the other functional units.

The first communication interface 628 can include different implementations depending on which functional units are being interfaced with the first communication unit 616. The first communication interface 628 can be implemented with technologies and techniques similar to the implementation of the first control interface 622.

The first user interface 618 allows a user (not shown) to interface and interact with the first device 102. The first user interface 618 can include an input device and an output device. Examples of the input device of the first user interface 618 can include a keypad, a touchpad, soft-keys, a keyboard, a microphone, an infrared sensor for receiving remote signals, or any combination thereof to provide data and communication inputs.

The first user interface 618 can include a first display interface 630. The first display interface 630 can include a display, a projector, a video screen, a speaker, or any combination thereof.

The first control unit 612 can operate the first user interface 618 to display information generated by the computing system 100. The first control unit 612 can also execute the first software 626 for the other functions of the computing system 100, including receiving location information from the location unit 620. The first control unit 612 can further execute the first software 626 for interaction with the communication path 104 via the first communication unit 616.

The second device 106 can be optimized for implementing the embodiment of the present invention in a multiple device embodiment with the second device 106. The second device 106 can provide the additional or higher performance processing power compared to the first device 102. The second device 106 can include a second control unit 634, a second communication unit 636, and a second user interface 638.

The second user interface 638 allows a user (not shown) to interface and interact with the second device 106. The second user interface 638 can include an input device and an output device. Examples of the input device of the second user interface 638 can include a keypad, a touchpad, soft-keys, a keyboard, a microphone, or any combination thereof to provide data and communication inputs. Examples of the output device of the second user interface 638 can include a second display interface 640. The second display interface 640 can include a display, a projector, a video screen, a speaker, or any combination thereof.

The second control unit 634 can execute a second software 642 to provide the intelligence of the second device 106 of the computing system 100. The second software 642 can operate in conjunction with the first software 626. The second control unit 634 can provide additional performance compared to the first control unit 612.

The second control unit 634 can operate the second user interface 638 to display information. The second control unit 634 can also execute the second software 642 for the other functions of the computing system 100, including operating the second communication unit 636 to communicate with the second device 106 over the communication path 104.

The second control unit 634 can be implemented in a number of different manners. For example, the second control unit 634 can be a processor, an embedded processor, a microprocessor, hardware control logic, a hardware finite state machine (FSM), a digital signal processor (DSP), or a combination thereof.

The second control unit 634 can include a second control interface 644. The second control interface 644 can be used for communication between the second control unit 634 and other functional units in the second device 106. The second control interface 644 can also be used for communication that is external to the second device 106.

The second control interface 644 can receive information from the other functional units or from external sources, or can transmit information to the other functional units or to external destinations. The external sources and the external destinations refer to sources and destinations physically separate from the second device 106.

The second control interface 644 can be implemented in different ways and can include different implementations depending on which functional units or external units are being interfaced with the second control interface 644. For example, the second control interface 644 can be implemented with a pressure sensor, an inertial sensor, a microelectromechanical system (MEMS), optical circuitry, waveguides, wireless circuitry, wireline circuitry, or a combination thereof.

A second storage unit 646 can store the second software 642. The second storage unit 646 can also store the relevant information, such as advertisements, points of interest (POI), navigation routing entries, or any combination thereof. The second storage unit 646 can be sized to provide the additional storage capacity to supplement the first storage unit 614.

For illustrative purposes, the second storage unit 646 is shown as a single element, although it is understood that the second storage unit 646 can be a distribution of storage elements. Also for illustrative purposes, the computing system 100 is shown with the second storage unit 646 as a single hierarchy storage system, although it is understood that the computing system 100 can have the second storage unit 646 in a different configuration. For example, the second storage unit 646 can be formed with different storage technologies forming a memory hierarchal system including different levels of caching, main memory, rotating media, or off-line storage.

The second storage unit 646 can be a volatile memory, a nonvolatile memory, an internal memory, an external memory, or a combination thereof. For example, the second storage unit 646 can be a nonvolatile storage such as non-volatile random access memory (NVRAM), Flash memory, disk storage, or a volatile storage such as static random access memory (SRAM).

The second storage unit 646 can include a second storage interface 648. The second storage interface 648 can be used for communication between other functional units in the second device 106. The second storage interface 648 can also be used for communication that is external to the second device 106.

The second storage interface 648 can receive information from the other functional units or from external sources, or can transmit information to the other functional units or to external destinations. The external sources and the external destinations refer to sources and destinations physically separate from the second device 106.

The second storage interface 648 can include different implementations depending on which functional units or external units are being interfaced with the second storage unit 646. The second storage interface 648 can be implemented with technologies and techniques similar to the implementation of the second control interface 644.

The second communication unit 636 can enable external communication to and from the second device 106. For example, the second communication unit 636 can permit the second device 106 to communicate with the first device 102 over the communication path 104.

The second communication unit 636 can also function as a communication hub allowing the second device 106 to function as part of the communication path 104 and not limited to be an end point or terminal unit to the communication path 104. The second communication unit 636 can include active and passive components, such as microelectronics or an antenna, for interaction with the communication path 104.

The second communication unit 636 can include a second communication interface 650. The second communication interface 650 can be used for communication between the second communication unit 636 and other functional units in the second device 106. The second communication interface 650 can receive information from the other functional units or can transmit information to the other functional units.

The second communication interface 650 can include different implementations depending on which functional units are being interfaced with the second communication unit 636. The second communication interface 650 can be implemented with technologies and techniques similar to the implementation of the second control interface 644.

The first communication unit 616 can couple with the communication path 104 to send information to the second device 106 in the first device transmission 608. The second device 106 can receive information in the second communication unit 636 from the first device transmission 608 of the communication path 104.

The second communication unit 636 can couple with the communication path 104 to send information to the first device 102 in the second device transmission 610. The first device 102 can receive information in the first communication unit 616 from the second device transmission 610 of the communication path 104. The computing system 100 can be executed by the first control unit 612, the second control unit 634, or a combination thereof.

For illustrative purposes, the second device 106 is shown with the partition having the second user interface 638, the second storage unit 646, the second control unit 634, and the second communication unit 636, although it is understood that the second device 106 can have a different partition. For example, the second software 642 can be partitioned differently such that some or all of its function can be in the second control unit 634 and the second communication unit 636. Also, the second device 106 can include other functional units not shown in FIG. 6 for clarity.

The third device 108 can include a third control unit 652, a third storage unit 654, a third communication unit 656, a third user interface 658, and a location unit 660. The third control unit 652 can include a third control interface 662. The third control unit 652 can execute a third software 666 to provide the intelligence of the computing system 100. The third control unit 652 can be implemented in a number of different manners. For example, the third control unit 652 can be a processor, an embedded processor, a microprocessor, a hardware control logic, a hardware finite state machine (FSM), a digital signal processor (DSP), or a combination thereof. The third control interface 662 can be used for communication between the third control unit 652 and other functional units in the third device 108. The third control interface 662 can also be used for communication that is external to the third device 108.

The third control interface 662 can receive information from the other functional units or from external sources, or can transmit information to the other functional units or to external destinations. The external sources and the external destinations refer to sources and destinations physically separate to the third device 108.

The third control interface 662 can be implemented in different ways and can include different implementations depending on which functional units or external units are being interfaced with the third control interface 662. For example, the third control interface 662 can be implemented with a pressure sensor, an inertial sensor, a microelectromechanical system (MEMS), optical circuitry, waveguides, wireless circuitry, wireline circuitry, or a combination thereof.

The location unit 660 can generate location information, current heading, and current speed of the third device 108, as examples. The location unit 660 can be implemented in many ways. For example, the location unit 660 can function as at least a part of a global positioning system (GPS), an inertial navigation system, a cellular-tower location system, a pressure location system, or any combination thereof.

The location unit 660 can include a location interface 672. The location interface 672 can be used for communication between the location unit 660 and other functional units in the third device 108. The location interface 672 can also be used for communication that is external to the third device 108.

The location interface 672 can receive information from the other functional units or from external sources, or can transmit information to the other functional units or to external destinations. The external sources and the external destinations refer to sources and destinations physically separate to the third device 108.

The location interface 672 can include different implementations depending on which functional units or external units are being interfaced with the location unit 660. The location interface 672 can be implemented with technologies and techniques similar to the implementation of the third control interface 662.

The third storage unit 654 can store the third software 666. The third storage unit 654 can also store the relevant information, such as advertisements, points of interest (POI), navigation routing entries, or any combination thereof.

The third storage unit 654 can be a volatile memory, a nonvolatile memory, an internal memory, an external memory, or a combination thereof. For example, the third storage unit 654 can be a nonvolatile storage such as non-volatile random access memory (NVRAM), Flash memory, disk storage, or a volatile storage such as static random access memory (SRAM).

The third storage unit 654 can include a third storage interface 664. The third storage interface 664 can be used for communication between the location unit 660 and other functional units in the third device 108. The third storage interface 664 can also be used for communication that is external to the third device 108.

The third storage interface 664 can receive information from the other functional units or from external sources, or can transmit information to the other functional units or to external destinations. The external sources and the external destinations refer to sources and destinations physically separate to the third device 108.

The third storage interface 664 can include different implementations depending on which functional units or external units are being interfaced with the third storage unit 654. The third storage interface 664 can be implemented with technologies and techniques similar to the implementation of the third control interface 662.

The third communication unit 656 can enable external communication to and from the third device 108. For example, the third communication unit 656 can permit the third device 108 to communicate with the second device 106 of FIG. 1, an attachment, such as a peripheral device or a computer desktop, and the communication path 104.

The third communication unit 656 can also function as a communication hub allowing the third device 108 to function as part of the communication path 104 and not limited to be an end point or terminal unit to the communication path 104. The third communication unit 656 can include active and passive components, such as microelectronics or an antenna, for interaction with the communication path 104.

The third communication unit 656 can include a third communication interface 668. The third communication interface 668 can be used for communication between the third communication unit 656 and other functional units in the third device 108. The third communication interface 668 can receive information from the other functional units or can transmit information to the other functional units.

The third communication interface 668 can include different implementations depending on which functional units are being interfaced with the third communication unit 656. The third communication interface 668 can be implemented with technologies and techniques similar to the implementation of the third control interface 662.

The third user interface 658 allows a user (not shown) to interface and interact with the third device 108. The third user interface 658 can include an input device and an output device. Examples of the input device of the third user interface 658 can include a keypad, a touchpad, soft-keys, a keyboard, a microphone, or any combination thereof to provide data and communication inputs.

The third user interface 658 can include a third display interface 670. The third display interface 670 can include a display, a projector, a video screen, a speaker, or any combination thereof.

The third control unit 652 can operate the third user interface 658 to display information generated by the computing system 100. The third control unit 652 can also execute the third software 666 for the other functions of the computing system 100, including receiving location information from the location unit 660. The third control unit 652 can further execute the third software 666 for interaction with the communication path 104 via the third communication unit 656.

The functional units in the first device 102 can work individually and independently of the other functional units. The first device 102 can work individually and independently from the second device 106, the third device 108, and the communication path 104.

The functional units in the second device 106 can work individually and independently of the other functional units. The second device 106 can work individually and independently from the first device 102, the third device 108, and the communication path 104.

The functional units in the third device 108 can work individually and independently of the other functional units. The third device 108 can work individually and independently from the first device 102, the second device 106, and the communication path 104.

For illustrative purposes, the computing system 100 is described by operation of the first device 102, the second device 106, and the third device 108. It is understood that the first device 102, the second device 106, the third device 108 can operate any of the modules and functions of the computing system 100. For example, the first device 102 is described to operate the location unit 620, although it is understood that the second device 106 or the third device 108 can also operate the location unit 620.

A first detecting sensor 674 can be the detecting sensor 420 of FIG. 4. Examples of the first detecting sensor 674 can include accelerometer, magnetometer, gyroscope, microphone, or the combination thereof.

A second detecting sensor 676 can be the detecting sensor 420. Examples of the second detecting sensor 676 can include accelerometer, magnetometer, gyroscope, microphone, or the combination thereof.

A third detecting sensor 678 can be the detecting sensor 420. Examples of the third detecting sensor 678 can include accelerometer, magnetometer, gyroscope, microphone, or the combination thereof.

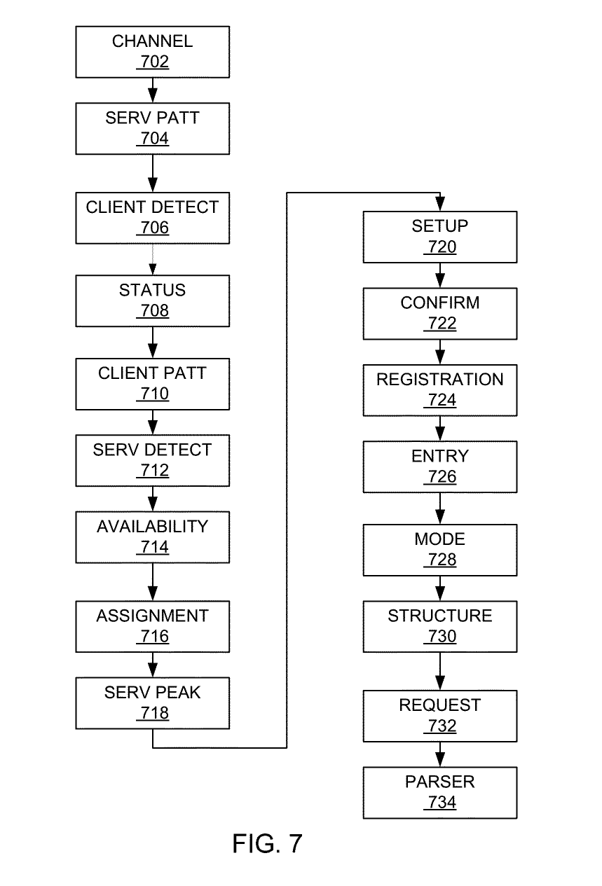

Referring now to FIG. 7, therein is shown a control flow 700 of the computing system 100 of FIG. 1. For clarity and brevity, the discussion of the control flow 700 will focus on the first device 102 of FIG. 1 or the third device 108 of FIG. 1 communicating with the second device 106 of FIG. 1. However, the first device 102, the second device 106, the third device 108, or a combination thereof can be discussed interchangeably. The discussion of the specificity of the modules pertaining to the first device 102, the second device 106, the third device 108, or a combination thereof will be discussed when appropriate.

For further example, the first device 102 or the third device 108 can represent the device used by the user represented as the agent device 202 of FIG. 2. The second device 106 can represent the electronic device 204 of FIG. 2 communicated by the first device 102, the third device 108, or a combination thereof.

The computing system 100 can include a channel module 702. The channel module 702 generates the channel bin 502 of FIG. 5. For example, the channel module 702 can generate the channel bin 502 representing a plurality of the communication channel 504 of FIG. 5. For further example, the channel module 702 can generate the channel bin 502 by grouping a plurality of the communication channel 504 within the frequency range 510 of FIG. 5.

The channel module 702 can generate the channel bin 502 in a number of ways. For example, the channel module 702 can generate the channel bin 502 by separating the frequency range 510 with the frequency interval 512 of FIG. 5. For a specific example, the frequency range 510 can include a plurality of the communication frequency 506 of FIG. 5 ranging from 18 kHz to 21 kHz. The frequency interval 512 can represent 300 hertz (Hz). As an example, the channel module 702 can generate a plurality of the communication channel 504 of 10 channels based on (21000 Hz-18000 Hz)/300 Hz.

The channel module 702 can generate the channel bin 502 by grouping the plurality of the communication channel 504. For example, the channel module 702 can assign a plurality of the communication channel 504 within the frequency range 510 from 18.01 kHz to 19.50 kHz as one instance of the channel bin 502. The channel module 702 can assign a plurality of the communication channel 504 within the frequency range 510 from 19.51 kHz to 21.00 kHz as another instance of the channel bin 502. The channel module 702 can generate the channel bin 502 having more than two instances of the channel bin 502 by changing the frequency range 510, the frequency interval 512, or a combination thereof. The channel module 702 can communicate the channel bin 502 to a server pattern module 704.

The computing system 100 can include the server pattern module 704, which can couple to the channel module 702. The server pattern module 704 generates the server recognition pattern 302 of FIG. 3. For example, the server pattern module 704 can generate the server recognition pattern 302 based on the communication frequency 506, the frequency range 510, or a combination thereof.

More specifically, the server pattern module 704 can generate the server recognition pattern 302 based on the communication frequency 506 outside of the frequency range 510 determined for the channel bin 502. For example, the server pattern module 704 can generate the server recognition pattern 302 with the communication frequency 506 that is higher or lower than a plurality of the communication frequency 506 within the frequency range 510. For a specific example, the frequency range 510 can represent a range from 18 kHz to 21 kHz. The server pattern module 704 can generate the server recognition pattern 302 with the communication frequency 506 of 21.5 kHz. The server pattern module 704 can communicate the server recognition pattern 302 to a client detection module 706.

The computing system 100 can include the client detection module 706. The client detection module 706 detects the server presence 226 of FIG. 2. For example, the client detection module 706 can detect the server presence 226 based on the server recognition pattern 302.

The client detection module 706 can detect the server presence 226 in a number of ways. For example, the agent device 202 can detect the server recognition pattern 302 if the agent device 202 is within the detection proximity 222 of FIG. 2. Once the server recognition pattern 302 is detected, the client detection module 706 can determine that the server presence 226 of the electronic device 204.

For further example, the client detection module 706 can determine the server presence 226 based on the communication frequency 506 of the server recognition pattern 302. The communication frequency 506 for the server recognition pattern 302 for a particular instance of the electronic device 204 can be defined within the agent device 202. More specifically, as discussed above, the communication frequency 506 for the server recognition pattern 302 can represent 21.5 kHz. By detecting the server recognition pattern 302 with a particular instance of the communication frequency 506, the client detection module 706 can detect the server presence 226. The client detection module 706 can communicate the server presence 226 to a status module 708.

The computing system 100 can include the status module 708, which can couple to the client detection module 706. The status module 708 changes the application status 236 of FIG. 2. For example, the status module 708 can change the application status 236 of the device application 234 of FIG. 2 on the agent device 202. More specifically, the status module 708 can change the application status 236 to “activate” the device application 234 on the agent device 202 to control the electronic device 204 based on detecting the server presence 226.

For another example, the status module 708 can maintain the application status 236. More specifically, the application status 236 can represent the user using the device application 234 on the agent device 202 irrelevant to controlling the electronic device 204. To avoid interrupting the user, the status module 708 can maintain the application status 236 for the device application 234 currently being used to avoid communicating with the electronic device 204. The status module 708 can communicate the application status 236 to a client pattern module 710.

The computing system 100 can include the client pattern module 710, which can couple to the status module 708. The client pattern module 710 generates the client recognition pattern 304 of FIG. 3. For example, the client pattern module 710 can generate the client recognition pattern 304 based on the communication frequency 506, the frequency range 510, or a combination thereof.

More specifically, the client pattern module 710 can generate the client recognition pattern 304 based on the communication frequency 506 outside of the frequency range 510 determined for the channel bin 502, different from the server recognition pattern 302, or a combination thereof. For example, the client pattern module 710 can generate the client recognition pattern 304 with the communication frequency 506 that is higher or lower than a plurality of the communication frequency 506 within the frequency range 510, the server recognition pattern 302, or a combination thereof. For a specific example, the frequency range 510 can represent a range from 18 kHz to 21 kHz. As stated above, the server recognition pattern 302 can have the communication frequency 506 of 21.5 kHz. The client pattern module 710 can generate the client recognition pattern 304 with the communication frequency 506 of 22 kHz. The client pattern module 710 can communicate the client recognition pattern 304 to a server detection module 712.

The computing system 100 can include the server detection module 712, which can couple to the client pattern module 710. The server detection module 712 detects the client presence 224 of FIG. 2. For example, the server detection module 712 can detect the client presence 224 based on the client recognition pattern 304.

The server detection module 712 can detect the client presence 224 in a number of ways. For example, the electronic device 204 can detect the client recognition pattern 304 if the agent device 202 is within the detection proximity 222. Once the client recognition pattern 304 is detected, the server detection module 712 can determine that the client presence 224 of the agent device 202.

For further example, the server detection module 712 can determine the client presence 224 based on the communication frequency 506 of the client recognition pattern 304. The communication frequency 506 for the client recognition pattern 304 for a particular instance of the agent device 202 can be defined within the electronic device 204. More specifically, as discussed above, the communication frequency 506 for the client recognition pattern 304 can represent 22 kHz. By detecting the client recognition pattern 304 with a particular instance of the communication frequency 506, the server detection module 712 can detect the client presence 224. The server detection module 712 can communicate the client presence 224 to an availability module 714.

The computing system 100 can include the availability module 714, which can couple to the server detection module 712. The availability module 714 determines the channel availability 516 of FIG. 5. For example, the availability module 714 can determine the channel availability 516 based on the client presence 224.

The availability module 714 can determine the channel availability 516 in a number of ways. For example, the availability module 714 can scan the channel bin 502 to determine the channel occupancy 514 of FIG. 5 of the communication channel 504. As an example, two instances of the channel bin 502 can be available. If the channel occupancy 514 for either instance or both instances of the channel bin 502 is unoccupied, the availability module 714 can determine the channel availability 516 for the channel bin 502 as “available for assignment.” In contrast, if the channel occupancy 514 for both instances of the channel bin 502 are assigned, the availability module 714 can determine the channel availability 516 as “unavailable for assignment.”

For another example, the availability module 714 can determine the channel availability 516 based on comparing the detection quantity 242 of FIG. 2 and the channel occupancy 514. More specifically, if the detection quantity 242 exceeds the number of the channel occupancy 514, the availability module 714 can determine the channel availability 516 as unavailable. In contrast, if the detection quantity 242 meets or below the number of the channel occupancy 514, the availability module 714 can determine the channel availability 516 as available.

For a specific example, the availability module 714 can determine the detection quantity 242 based on a number of instances of the client recognition pattern 304 detected. The channel occupancy 514 can represent two instances of the channel bin 502 available. The client recognition pattern 304 detected can represent two instances. The availability module 714 can determine the channel availability 516 as available. The availability module 714 can communicate the channel availability 516 to an assignment module 716.

The computing system 100 can include the assignment module 716, which can couple to the availability module 714. The assignment module 716 assigns the channel bin 502. For example, the assignment module 716 can assign the channel bin 502 based on the channel availability 516.

The assignment module 716 can assign the channel bin 502 in a number of ways. For example, the assignment module 716 can assign the channel bin 502 to the agent device 202 based on the channel availability 516. More specifically, if the channel occupancy 514 is available, thus, the channel availability 516 is “available for assignment,” the assignment module 716 can assign the channel bin 502 to the agent device 202.

For another example, the assignment module 716 can assign the channel bin 502 based on the detection quantity 242, the device priority 246 of FIG. 2, the user profile 248 of FIG. 2, the request timing 244 of FIG. 2, or a combination thereof. More specifically, the channel availability 516 can represent two instances of the channel bin 502 available. The detection quantity 242 can represent three instances of the agent device 202 communicating the client recognition pattern 304. The assignment module 716 can assign the two instances of the channel bin 502 to the two devices of the agent device 202.

It has been discovered that the computing system 100 assigning a plurality of the channel bin 502 to a plurality of the agent device 202 improves the efficiency of operating the electronic device 204, the computing system 100, or a combination thereof. By assigning each instances of the channel bin 502, the computing system 100 can allow more than instance of the agent device 202 to access the device functionality 208 of FIG. 2 of the electronic device 204. As a result, the computing system 100 can improve the efficiency of controlling the electronic device 204 for enhanced user experience operating the electronic device 204, the computing system 100, or a combination thereof.

Continuing with the example, the assignment module 716 can assign the channel bin 502 based on the device priority 246, the user profile 248, the request timing 244, or a combination thereof for managing a plurality of the agent device 202. More specifically, one instance of the user profile 248 can represent the father and another instance of the user profile 248 can represent the son. The device priority 246 can represent the agent device 202 operated by the father can have a higher priority than the agent device 202 operated by the son. As a result, the assignment module 716 can assign the available instance of the channel bin 502 to the agent device 202 operated by the father before the agent device 202 operated by the son. In contrast, the request timing 244 of the agent device 202 operated by the son made the client presence 224 known to the electronic device 204 before the agent device 202 operated by the father. The assignment module 716 can assign the channel bin 502 to the agent device 202 operated the son before the agent device 202 operated by the father.

It has been discovered that the computing system 100 assigning the channel bin 502 based on the device priority 246 improves the efficiency of operating the electronic device 204, the computing system 100, or a combination thereof. By assigning each instances of the channel bin 502 based on the device priority 246, the computing system 100 can allow more than instance of the agent device 202 to access the device functionality 208 of FIG. 2 of the electronic device 204 and reduce conflict as to which instance of the agent device 202 to occupy the channel bin 502. As a result, the computing system 100 can improve the efficiency of controlling the electronic device 204 for enhanced user experience operating the electronic device 204, the computing system 100, or a combination thereof.

For further example, the assignment module 716 can override the channel occupancy 514 to create the channel availability 516 for the agent device 202 having the device priority 246 higher than the agent device 202 already occupying the channel occupancy 514. For example, the channel bin 502 can be occupied by the agent device 202 operated by the son and the agent device 202 operated by the mother. If the client presence 224 of the agent device 202 operated by the father is within the detection proximity 222, the assignment module 716 can cancel the channel occupancy 514 of the agent device 202 with the lowest instance of the device priority 246 to reassign the channel bin 502 made available to the agent device 202 operated by the father.

For another example, the assignment module 716 can assign the channel bin 502 based on the communication frequency 506 of the client recognition pattern 304. More specifically, one instance of the agent device 202 can communicate the client recognition pattern 304 with the communication frequency 506 of 22.0 kHz. Another instance of the agent device 202 can communicate the client recognition pattern 304 with the communication frequency 506 of 22.5 kHz. The assignment module 716 can assign the channel bin 502 to the agent device 202 communicating with the client recognition pattern 304 having the highest or the lowest instance of the communication frequency 506 over the agent device 202 communicating with the client recognition pattern 304 having lowest or the highest instance, respectively, of the communication frequency 506. The assignment module 716 can communicate the channel bin 502 assigned to a server peak module 718.

The computing system 100 can include the server peak module 718, which can couple to the assignment module 716. The server peak module 718 generates the peak pattern 306 of FIG. 3. For example, the server peak module 718 can generate the peak pattern 306 based on the channel availability 516. More specifically, the channel availability 516 can indicate that the channel bin 502 representing the frequency range 510 between 18.01 kHz to 19.50 kHz as available. The server peak module 718 can generate the peak pattern 306 having the channel peak 508 of FIG. 5 based on determining the communication frequency 506 with the highest amplitude within the channel bin 502. In contrast, if the channel availability 516 is unavailable, the server peak module 718 can remain silent and not generate the peak pattern 306. More specifically, the server peak module 718 can communicate the peak pattern 306 to a setup module 720 based on whether the peak pattern 306 is generated to notify the agent device 202 of being assigned with the channel bin 502.

The computing system 100 can include the setup module 720, which can couple to the server peak module 718. The setup module 720 determines the setup possibility 308 of FIG. 3. For example, the setup module 720 can determine the setup possibility 308 based on the peak pattern 306, the request window 310 of FIG. 3, or a combination thereof.

For a specific example, the setup module 720 can determine the setup possibility 308 based on the agent device 202 receiving the peak pattern 306 within the request window 310. More specifically, the setup module 720 can determine the setup possibility 308 for the agent device 202 to occupy the channel bin 502 by detecting the channel peak 508 from the peak pattern 306. If the setup module 720 did not receive the peak pattern 306 within the request window 310, the agent device 202 can recognize that the channel availability 516 as unavailable, the electronic device 204 is busy, or a combination thereof. The setup module 720 can communicate the setup possibility 308 to a confirmation module 722.

The computing system 100 can include the confirmation module 722, which can couple to the setup module 720. The confirmation module 722 generates the confirmation pattern 312 of FIG. 3. For example, the confirmation module 722 can generate the confirmation pattern 312 having the channel peak 508.

For a specific example, the confirmation module 722 can generate the confirmation pattern 312 to notify the electronic device 204 that the agent device 202 is aware of the assigned instance of the channel bin 502. Moreover, the confirmation module 722 can generate the confirmation pattern 312 with the channel peak 508 of the peak pattern 306 to indicate the awareness of the channel bin 502 assigned by the electronic device 204 to the agent device 202. The confirmation module 722 can communicate the confirmation pattern 312 to a registration module 724.

The computing system 100 can include the registration module 724, which can couple to the confirmation module 722. The registration module 724 determines the device registration 314 of FIG. 3. For example, the registration module 724 can determine the device registration 314 based on the confirmation pattern 312. More specifically, the registration module 724 can determine the device registration 314 for the agent device 202 as registered based on the agent device 202 communicating the confirmation pattern 312. The electronic device 204 can register the agent device 202 for the channel bin 502 based on the confirmation pattern 312 to allow the agent device 202 to control the electronic device 204. The registration module 724 can communicate the device registration 314 to an entry module 726.

The computing system 100 can include the entry module 726, which can couple to the registration module 724. The entry module 726 determines the entry gesture 402 of FIG. 4. For example, the entry module 726 can determine the entry gesture 402 based on the user entry 404 of FIG. 4, the detection area 406 of FIG. 4, the device posture 408 of FIG. 4, or a combination thereof.

The entry module 726 can determine the entry gesture 402 in a number of ways. For example, the entry module 726 can determine the entry gesture 402 based on detecting the user entry 404 on the detection area 406 of the agent device 202. More specifically, the detection area 406 can represent the display interface 414 of FIG. 4, the device backside 416 of FIG. 4, the device side 418 of FIG. 4, or a combination thereof. The user entry 404 can represent a tap on the display interface 414. The entry module 726 can determine the entry gesture 402 as a plurality of a tap on the device backside 416 based on determining the contact duration 410 of FIG. 4 of the user entry 404 on the detection area 406.

For another example, the entry module 726 can determine the entry gesture 402 based on the device posture 408, the movement direction 412 of FIG. 4, or a combination thereof of the agent device 202. The user entry 404 can change the device posture 408 of the agent device 202 by turning the device backside 416 facing the user and display interface 414 facing away from the user. The entry module 726 can determine the change in the device posture 408 with the detecting sensor 420 of FIG. 4 representing the gyroscope. As an example, the entry module 726 can determine the device posture 408 of whether the movement direction 412 is clockwise or counterclockwise with the detecting sensor 420. As a result, the entry module 726 can determine the entry gesture 402 as turning the agent device 202 clockwise or counterclockwise based on the movement direction 412 of the device posture 408 changing. The entry module 726 can communicate the entry gesture 402 to a mode module 728.

The computing system 100 can include the mode module 728, which can couple to the entry module 726. The mode module 728 determines the mode type 228 of FIG. 2. For example, the mode module 728 can determine the mode type 228 based on the entry gesture 402.

The mode module 728 can determine the mode type 228 in a number of ways. For example, the mode module 728 can determine the mode type 228 based on the entry gesture 402. As an example, the mode type 228 can include the transmission mode 230 of FIG. 2 or the non-transmission mode 232 of FIG. 2. Moreover, the mode module 728 can have the mode type 228 predefined based on the entry gesture 402. For example, the mode module 728 can continuously run the transmission mode 230 if the entry gesture 402 represents a continuous contact on the display interface 414 by the user of the computing system 100. Continuing with the previous example, the entry gesture 402 can represent taps on the display interface 414. The mode module 728 can determine the mode type 228 to represent the transmission mode 230.

For a different example, the mode module 728 can update the mode type 228 based on the inactivity time 238 of FIG. 2, the time threshold 240 of FIG. 2, the server recognition pattern 302, or a combination thereof. For a specific example, the mode module 728 can calculate the inactivity time 238 based on the last time the user entry 404 made contact with the agent device 202. If the inactivity time 238 meets or exceeds the time threshold 240, the mode module 728 can determine the mode type 228 as the non-transmission mode 232. For another example, the mode module 728 can determine the mode type 228 as the non-transmission mode 232 if the agent device 202 can no longer detect the server recognition pattern 302 or outside of the detection proximity 222. The mode module 728 can communicate the mode type 228 to a structure module 730.

For illustrative purposes, the status module 708 is described with changing the application status 236 based on detecting the server presence 226, although the status module 708 can operate differently. For example, the status module 708 can change the application status 236 based on the inactivity time 238 meeting or exceeding the time threshold 240. More specifically, the status module 708 can change the application status 236 from “active” to “inactive” if the inactivity time 238 meets or exceeds the time threshold 240.

The computing system 100 can include the structure module 730, which can couple to the mode module 728. The structure module 730 generates the instruction code 212 of FIG. 2. For example, the structure module 730 can generate the instruction code 212 having the action segment 214 of FIG. 2, the data segment 216 of FIG. 2, or a combination thereof.

The structure module 730 can generate the instruction code 212 in a number of ways. For example, the length of the instruction code 212 can represent 6 bits long. The structure module 730 can generate the instruction code 212 having the action segment 214 and the data segment 216 that are 3 bits long each.

For a different example, the structure module 730 can customize the instruction code 212 by generating the instruction code 212 having the control segment 218 of FIG. 2 in addition to the action segment 214 and the data segment 216. More specifically, the structure module 730 can generate the instruction code 212 having the control segment 218 based on the action type 220 of FIG. 2.

For a specific example, if the action type 220 can represent a binary action, such as on/off, forward/backward, or previous/next, the structure module 730 can generate the instruction code 212 having the data segment 216 that is 1 bit long. Further, the structure module 730 can generate the instruction code 212 having the control segment 218 with a value of 0 to indicate that the action type 220 represents a binary action. Additionally, the structure module 730 can generate the instruction code 212 having the action segment 214 that is 4 bits long.

In contrast, the action type 220 can represent a non-binary action, such as volume control, which requires finer scale in data representation. As a result, the structure module 730 can generate the data segment 216 that is 3 bits long to reserve more bits. Additionally, the structure module 730 can generate the control segment 218 having the value of 1 to indicate that the action type 220 represents a non-binary action. The structure module 730 can communicate the instruction code 212 to a request module 732.

The computing system 100 can include the request module 732, which can couple to the structure module 730. The request module 732 generates the activity request pattern 210 of FIG. 2. For example, the request module 732 can generate the activity request pattern 210 based on the instruction code 212, the entry gesture 402, or a combination thereof.

The request module 732 can generate the activity request pattern 210 in a number of ways. For example, the request module 732 can generate the activity request pattern 210 based on the entry gesture 402 on the detection area 406. More specifically, the entry gesture 402 can represent a tap on the device backside 416. The request module 732 can generate the activity request pattern 210 having the instruction code 212 to switch the action type 220 for controlling the electronic device 204.

For a specific example, the action type 220 can represent “on/off” to turn on or off the electronic device 204. The instruction code 212 can include the action segment 214 and the data segment 216 to request the electronic device 204 to turn on or off. The request module 732 can generate the activity request pattern 210 with the instruction code 212 to turn on the electronic device 204.

Once the electronic device 204 is turned on, the user of the computing system 100 can make the user entry 404 representing a tap to the device backside 416 of the agent device 202 to switch the action type 220. As an example, the user can switch the action type 220 from “on/off” to “volume control.” As a result, the request module 732 can update the activity request pattern 210 to include the instruction code 212 for “volume control” to be transmitted to the electronic device 204.

For a different example, the request module 732 can generate the activity request pattern 210 based on the entry gesture 402 from the change in the device posture 408. More specifically, the display interface 414 of the agent device 202 can initially face towards the user. The user can rotate the agent device 202 with the movement direction 412 of clockwise or counterclockwise to turn the device backside 416 to face towards the user. The request module 732 can generate the activity request pattern 210 to include the instruction code 212 based on the movement direction 412. Moreover, the request module 732 can capture the device posture 408 to change the modulation of the activity request pattern 210 to indicate the change in the instruction code 212. For example, the movement direction 412 of counterclockwise can represent “volume down” while the movement direction 412 of clockwise can represent “volume up.” The request module 732 can communicate the activity request pattern 210 to a parser module 734.

The computing system 100 can include the parser module 734, which can couple to the request module 732. The parser module 734 generates the activity command 206 of FIG. 2. For example, the parser module 734 can generate the activity command 206 based on the activity request pattern 210.

For a specific example, the parser module 734 can generate the activity command 206 by demodulating the activity request pattern 210. The parser module 734 can listen to the activity request pattern 210 via the detecting sensor 420 of the agent device 202. The parser module 734 can perform, for example, Fast Fourier Transform to convert the activity request pattern 210 representing an audio data from the time domain to frequency domain. Since the activity request pattern 210 may be noisy, the parser module 734 can smooth the activity request pattern 210 by applying, for example, Hamming Filter to reduce the leaking energy at the side slope. Subsequently, the parser module 734 can amplify the activity request pattern 210.

For further example, the parser module 734 can recover the instruction code 212 through detecting the channel peak 508 of the activity request pattern 210. The parser module 734 can generate the activity command 206 by decoding the instruction code 212 to obtain the information provided in the action segment 214 and the data segment 216.

The physical transformation for detecting the server presence 226 results in the movement in the physical world, such as people using the first device 102, the second device 106, the third device 108, or a combination thereof, based on the operation of the computing system 100. As the movement in the physical world occurs, the movement itself creates additional information that is converted back into generating the client recognition pattern 304 for detecting the client presence 224 for the continued operation of the computing system 100 and to continue movement in the physical world.

The first software 626 of FIG. 6 of the first device 102 of FIG. 6 can include the computing system 100. For example, the first software 626 can include the channel module 702, the server pattern module 704, the client detection module 706, the status module 708, the client pattern module 710, the server detection module 712, the availability module 714, the assignment module 716, the server peak module 718, the setup module 720, the confirmation module 722, the registration module 724, the entry module 726, the mode module 728, the structure module 730, the request module 732, and the parser module 734.

The first control unit 612 of FIG. 6 can execute the first software 626 for the channel module 702 to generate the channel bin 502. The first control unit 612 can execute the first software 626 for the server pattern module 704 to generate the server recognition pattern 302.

The first control unit 612 can execute the first software 626 for the client detection module 706 to detect the server presence 226. The first control unit 612 can execute the first software 626 for the status module 708 to change the application status 236.

The first control unit 612 can execute the first software 626 for the client pattern module 710 to generate the client recognition pattern 304. The first control unit 612 can execute the first software 626 for the server detection module 712 to detect the client presence 224. The first control unit 612 can execute the first software 626 for the availability module 714 to determine the channel availability 516. The first control unit 612 can execute the first software 626 for the assignment module 716 to assign the channel bin 502.

The first control unit 612 can execute the first software 626 for the server peak module 718 to generate the peak pattern 306. The first control unit 612 can execute the first software 626 for the setup module 720 to determine the setup possibility 308. The first control unit 612 can execute the first software 626 for the confirmation module 722 to generate the confirmation pattern 312. The first control unit 612 can execute the first software 626 for the registration module 724 to determine the device registration 314.

The first control unit 612 can execute the first software 626 for the entry module 726 to determine the entry gesture 402. The first control unit 612 can execute the first software 626 for the mode module 728 to determine the mode type 228. The first control unit 612 can execute the first software 626 for the structure module 730 to generate the instruction code 212. The first control unit 612 can execute the first software 626 for the request module 732 to generate the activity request pattern 210. The first control unit 612 can execute the first software 626 for the parser module 734 to generate the activity command 206.

The second software 642 of FIG. 6 of the second device 106 of FIG. 6 can include the computing system 100. For example, the second software 642 can include the channel module 702, the server pattern module 704, the client detection module 706, the status module 708, the client pattern module 710, the server detection module 712, the availability module 714, the assignment module 716, the server peak module 718, the setup module 720, the confirmation module 722, the registration module 724, the entry module 726, the mode module 728, the structure module 730, the request module 732, and the parser module 734.

The second control unit 634 of FIG. 6 can execute the second software 642 for the channel module 702 to generate the channel bin 502. The second control unit 634 can execute the second software 642 for the server pattern module 704 to generate the server recognition pattern 302.

The second control unit 634 can execute the second software 642 for the client detection module 706 to detect the server presence 226. The second control unit 634 can execute the second software 642 for the status module 708 to change the application status 236.

The second control unit 634 can execute the second software 642 for the client pattern module 710 to generate the client recognition pattern 304. The second control unit 634 can execute the second software 642 for the server detection module 712 to detect the client presence 224. The second control unit 634 can execute the second software 642 for the availability module 714 to determine the channel availability 516. The second control unit 634 can execute the second software 642 for the assignment module 716 to assign the channel bin 502.

The second control unit 634 can execute the second software 642 for the server peak module 718 to generate the peak pattern 306. The second control unit 634 can execute the second software 642 for the setup module 720 to determine the setup possibility 308. The second control unit 634 can execute the second software 642 for the confirmation module 722 to generate the confirmation pattern 312. The second control unit 634 can execute the second software 642 for the registration module 724 to determine the device registration 314.

The second control unit 634 can execute the second software 642 for the entry module 726 to determine the entry gesture 402. The second control unit 634 can execute the second software 642 for the mode module 728 to determine the mode type 228. The second control unit 634 can execute the second software 642 for the structure module 730 to generate the instruction code 212. The second control unit 634 can execute the second software 642 for the request module 732 to generate the activity request pattern 210. The second control unit 634 can execute the second software 642 for the parser module 734 to generate the activity command 206.

The third software 666 of FIG. 6 of the third device 108 of FIG. 6 can include the computing system 100. For example, the third software 666 can include the channel module 702, the server pattern module 704, the client detection module 706, the status module 708, the client pattern module 710, the server detection module 712, the availability module 714, the assignment module 716, the server peak module 718, the setup module 720, the confirmation module 722, the registration module 724, the entry module 726, the mode module 728, the structure module 730, the request module 732, and the parser module 734.

The third control unit 652 of FIG. 6 can execute the third software 666 for the channel module 702 to generate the channel bin 502. The third control unit 652 can execute the third software 666 for the server pattern module 704 to generate the server recognition pattern 302.

The third control unit 652 can execute the third software 666 for the client detection module 706 to detect the server presence 226. The third control unit 652 can execute the third software 666 for the status module 708 to change the application status 236.

The third control unit 652 can execute the third software 666 for the client pattern module 710 to generate the client recognition pattern 304. The third control unit 652 can execute the third software 666 for the server detection module 712 to detect the client presence 224. The third control unit 652 can execute the third software 666 for the availability module 714 to determine the channel availability 516. The third control unit 652 can execute the third software 666 for the assignment module 716 to assign the channel bin 502.

The third control unit 652 can execute the third software 666 for the server peak module 718 to generate the peak pattern 306. The third control unit 652 can execute the third software 666 for the setup module 720 to determine the setup possibility 308. The third control unit 652 can execute the third software 666 for the confirmation module 722 to generate the confirmation pattern 312. The third control unit 652 can execute the third software 666 for the registration module 724 to determine the device registration 314.

The third control unit 652 can execute the third software 666 for the entry module 726 to determine the entry gesture 402. The third control unit 652 can execute the third software 666 for the mode module 728 to determine the mode type 228. The third control unit 652 can execute the third software 666 for the structure module 730 to generate the instruction code 212. The third control unit 652 can execute the third software 666 for the request module 732 to generate the activity request pattern 210. The third control unit 652 can execute the third software 666 for the parser module 734 to generate the activity command 206.

The computing system 100 can be partitioned between the first software 626, the second software 642, and the third software 666. For example, the second software 642 can include the channel module 702, the server pattern module 704, the server detection module 712, the availability module 714, the assignment module 716, the server peak module 718, the registration module 724, the parser module 734, or a combination thereof. The second control unit 634 can execute modules partitioned on the second software 642 as previously described.

The first software 626 can include the client detection module 706, the status module 708, the client pattern module 710, the setup module 720, the confirmation module 722, the entry module 726, the mode module 728, the structure module 730, the request module 732, or a combination thereof. Based on the size of the first storage unit 614 of FIG. 6, the first software 626 can include additional modules of the computing system 100. The first control unit 612 can execute the modules partitioned on the first software 626 as previously described.

The third software 666 can include the client detection module 706, the status module 708, the client pattern module 710, the setup module 720, the confirmation module 722, the entry module 726, the mode module 728, the structure module 730, the request module 732, or a combination thereof. Based on the size of the third storage unit 664 of FIG. 6, the third software 666 can include additional modules of the computing system 100. The third control unit 652 can execute the modules partitioned on the third software 666 as previously described.

The first control unit 612 can operate the first communication unit 616 of FIG. 6 to communicate the activity request pattern 210, the server request pattern 302, the client recognition pattern 304, the peak pattern 306, the confirmation pattern 312, or a combination thereof to or from the second device 106 through the communication path 104 of FIG. 1. The first control unit 612 can operate the first software 626 to operate the location unit 620. The second communication unit 636 of FIG. 6 can communicate the activity request pattern 210, the server request pattern 302, the client recognition pattern 304, the peak pattern 306, the confirmation pattern 312, or a combination thereof to or from the second device 106 through the communication path 104. The third communication unit 656 of FIG. 6 can communicate the activity request pattern 210, the server request pattern 302, the client recognition pattern 304, the peak pattern 306, the confirmation pattern 312, or a combination thereof to or from the second device 106 through the communication path 104. The first user interface 618 of FIG. 6, the second user interface 638 of FIG. 6, the third user interface 658 of FIG. 6, or a combination thereof can represent the detection area 406.

The computing system 100 describes the module functions or order as an example. The modules can be partitioned differently. For example, the availability module 714 and the assignment module 716 can be combined. Each of the modules can operate individually and independently of the other modules. Furthermore, data generated in one module can be used by another module without being directly coupled to each other. For example, the availability module 714 can receive the channel bin 502 from the channel module 702. Further, “communicating” can represent sending, receiving, or a combination thereof the data generated to or from another.

The modules described in this application can be hardware circuitry, hardware implementation, or hardware accelerators in the first control unit 612, the third control unit 652, or in the second control unit 634. The modules can also be hardware circuitry, hardware implementation, or hardware accelerators within the first device 102, the second device 106, or the third device 108 but outside of the first control unit 612, the second control unit 634, or the third control unit 652, respectively as depicted in FIG. 6. However, it is understood that the first control unit 612, the second control unit 634, the third control unit 652, or a combination thereof can collectively refer to all hardware accelerators for the modules.

The modules described in this application can be implemented as instructions stored on a non-transitory computer readable medium to be executed by the first control unit 612, the second control unit 634, the third control unit 652, or a combination thereof. The non-transitory computer medium can include the first storage unit 614 of FIG. 6, the second storage unit 646 of FIG. 6, the third storage unit 654 of FIG. 6, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

The control flow 700 of FIG. 7 is an embodiment of the present invention. The control flow 700 or a method 700 includes: determining a detection quantity based on a client recognition pattern received; assigning a channel bin based on comparing the detection quantity to a channel occupancy available; and generating an activity command with a control unit based on an activity request pattern assigned to the channel bin for controlling a device functionality of an electronic device. The method 700 further includes: determining an entry gesture based on a movement direction of a device posture; generating an instruction code having an action type of a device functionality; generating an activity request pattern with a control unit having the instruction code based on the entry gesture for controlling the device functionality of an electronic device.

It has been discovered the computing system 100 determining the detection quantity 242 based on the client recognition pattern 304 received can improve the efficiency of assigning the channel bin 502. By limiting the assignment of the channel bin 502 based on the channel occupancy 512, the computing system 100 can assign the agent device 202 to the channel bin 502 with the channel availability 516. As a result, the computing system 100 can generate the activity command 206 based on the activity request pattern 210 with the channel bin 502 assigned for optimal allocation of the communication channel 504 to control the device functionality 208 of the electronic device 204.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the embodiment of the present invention is that it valuably supports and services the historical trend of reducing costs, simplifying systems, and increasing performance. These and other valuable aspects of the embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a communication unit configured to communicate a client recognition pattern for detecting an agent device within a detection proximity; and
a control unit, coupled to the communication unit, configured to:
determine a detection quantity based on the client recognition pattern,
assign a channel bin based on comparing the detection quantity to a channel occupancy being available, and
generate an activity command based on an activity request pattern assigned to the channel bin for controlling a device functionality of an electronic device.

2. The system as claimed in claim 1 wherein the control unit is configured to determine a channel availability based on the channel occupancy of the channel bin.

3. The system as claimed in claim 1 wherein the control unit is configured to assign the channel bin based on a device priority for managing a plurality of the agent device.

4. The system as claimed in claim 1 wherein the control unit is configured to override the channel occupancy for creating a channel availability for the agent device having a higher instance of a device priority.

5. The system as claimed in claim 1 wherein the control unit is configured to generate a channel bin based on grouping a plurality of a communication channel within a frequency range.

6. A computing system comprising:
a control unit configured to:
determine an entry gesture based on a movement direction of a device posture,
generate an instruction code having an action type of a device functionality,
generate an activity request pattern having the instruction code based on the entry gesture, and
a communication unit, coupled to the control unit, configured to communicate an activity request pattern for controlling the device functionality of an electronic device.

7. The system as claimed in claim 6 wherein the control unit is configured to determine a mode type based on the entry gesture for activating the agent device.

8. The system as claimed in claim 6 wherein the control unit is configured to generate the instruction code having an action segment, a data segment, a control segment, or a combination thereof for specifying the action type to control the device functionality.

9. The system as claimed in claim 6 wherein the control unit is configured to determine a setup possibility based on receiving a peak pattern within a request window.

10. The system as claimed in claim 6 wherein the control unit is configured to generate the activity request pattern based on the entry gesture for switching the action type of the device functionality.

11. A method of operation of a computing system comprising:
determining a detection quantity based on a client recognition pattern received;
assigning a channel bin based on comparing the detection quantity to a channel occupancy available; and
generating an activity command with a control unit based on an activity request pattern assigned to the channel bin for controlling a device functionality of an electronic device.

12. The method as claimed in claim 11 further comprising determining a channel availability based on the channel occupancy of the channel bin.

13. The method as claimed in claim 11 wherein assigning the channel bin includes assigning the channel bin based on a device priority for managing a plurality of the agent device.

14. The method as claimed in claim 11 further comprising overriding the channel occupancy for creating a channel availability for the agent device having a higher instance of a device priority.

15. The method as claimed in claim 11 further comprising generating a channel bin based on grouping a plurality of a communication channel within a frequency range.

16. A method of operation of a computing system comprising:
determining an entry gesture based on a movement direction of a device posture;
generating an instruction code having an action type of a device functionality;
generating an activity request pattern with a control unit having the instruction code based on the entry gesture for controlling the device functionality of an electronic device.

17. The method as claimed in claim 16 further comprising determining a mode type based on the entry gesture for activating the agent device.

18. The method as claimed in claim 16 wherein generating the instruction code includes generating the instruction code having an action segment, a data segment, a control segment, or a combination thereof for specifying the action type to control the device functionality.

19. The method as claimed in claim 16 further comprising determining a setup possibility based on receiving a peak pattern within a request window.

20. The method as claimed in claim 16 wherein generating the activity request pattern includes generating the activity request pattern based on the entry gesture for switching the action type of the device functionality.

21. A non-transitory computer readable medium including instructions for execution by a control unit comprising:
determining a detection quantity based on a client recognition pattern received;
assigning a channel bin based on comparing the detection quantity to a channel occupancy available; and
generating an activity command based on an activity request pattern assigned to the channel bin for controlling a device functionality of an electronic device.

22. The non-transitory computer readable medium as claimed in claim 21 further comprising determining a channel availability based on the channel occupancy of the channel bin.

23. The non-transitory computer readable medium as claimed in claim 21 wherein assigning the channel bin includes assigning the channel bin based on a device priority for managing a plurality of the agent device.

24. The non-transitory computer readable medium as claimed in claim 21 further comprising overriding the channel occupancy for creating a channel availability for the agent device having a higher instance of a device priority.

25. The non-transitory computer readable medium as claimed in claim 21 further comprising generating a channel bin based on grouping a plurality of a communication channel within a frequency range.

26. A non-transitory computer readable medium including instructions for execution by a control unit comprising:
determining an entry gesture based on a movement direction of a device posture;
generating an instruction code having an action type of a device functionality;
generating an activity request pattern having the instruction code based on the entry gesture for controlling the device functionality of an electronic device.

27. The non-transitory computer readable medium as claimed in claim 26 further comprising determining a mode type based on the entry gesture for activating the agent device.

28. The non-transitory computer readable medium as claimed in claim 26 wherein generating the instruction code includes generating the instruction code having an action segment, a data segment, a control segment, or a combination thereof for specifying the action type to control the device functionality.

29. The non-transitory computer readable medium as claimed in claim 26 further comprising determining a setup possibility based on receiving a peak pattern within a request window.

30. The non-transitory computer readable medium as claimed in claim 26 wherein generating the activity request pattern includes generating the activity request pattern based on the entry gesture for switching the action type of the device functionality.
